(19) United States
(12) Patent Application Publication
(10) Pub. No.: US 2018/0059650 A1
(43) Pub. Date: Mar. 1, 2018

(54) TECHNIQUES FOR MULTIPLE APPLICATION BANKS IN A WELDING OR CUTTING SYSTEM

(71) Applicant: ESAB AB, Goteborg (SE)

(72) Inventor: Stefan Rickfjord, Kungalv (SE)

(21) Appl. No.: 15/687,494

(22) Filed: Aug. 27, 2017

Related U.S. Application Data
(60) Provisional application No. 62/382,050, filed on Aug. 31, 2016.

(51) Int. Cl. G05B 19/4155; G05B 19/4063; G06F 9/44

(52) U.S. Cl. CPC G05B 19/4155; G05B 19/4063; G05B 2219/45135; G05B 2219/36086; G06F 8/71

(57) ABSTRACT

Various embodiments are generally directed to techniques for selecting among multiple application software modules by a bootloader of a welding or cutting system. Techniques described herein may include a bootloader component of a welding system to determine that more than one application software module is available for the welding system. A display device may be configured to display user interface components configured to allow user selection of one or more application software module. An input device may be configured to receive a selection of one of the one or more application software modules. A processor of the welding system may be configured to execute the selected one or more application software modules.

### CROSS REFERENCE TO RELATED APPLICATIONS

This application claims the benefit of U.S. Provisional Patent Application No. 62/382,050 filed Aug. 31, 2016, the disclosure of which is incorporated by reference herein in its entirety.

### TECHNICAL FIELD

The present embodiments are related to techniques for multiple application software banks in a welding or cutting system.

### BACKGROUND

Welding and cutting systems may be limited to include a single application software module comprising one or more components required to operate the system. In some circumstances, a single application software module may be limited to a particular set of features. To use a welding or cutting system to perform a set of features outside of the single application software module functionality, a new application software module may need to be installed by overwriting the original. In other cases, new software versions may become available, and a welding or cutting system may require an upgrade. The installation process for new software on a welding or cutting system may be time-consuming, or error-prone. In some instances, a technical service specialist may be required to perform a software installation on a welding or cutting system, and specialized tools and validated software may be required as well. Thus, techniques for providing flexibility in the availability of application software modules on a welding and cutting system may be desired.

### SUMMARY

The following presents a simplified summary in order to provide a basic understanding of some novel embodiments described herein. This summary is not an extensive overview, and it is not intended to identify key/critical elements or to delineate the scope thereof. Its sole purpose is to present some concepts in a simplified form as a prelude to the more detailed description that is presented later.

Various embodiments are generally directed to techniques for selecting among multiple application software modules by a bootloader of a welding or cutting system. Techniques described herein may include a bootloader component of a welding system to determine that more than one application software module is available for the welding system. A display device may be configured to display user interface components configured to allow user selection of one or more application software modules. An input device may be configured to receive a selection of one of the one or more application software modules. A processor of the welding system may be configured to execute the selected one or more application software modules. Other embodiments are described and claimed.

To the accomplishment of the foregoing and related ends, certain illustrative aspects are described herein in connection with the following description and the annexed drawings. These aspects are indicative of the various ways in which the principles disclosed herein can be practiced and all aspects and equivalents thereof are intended to be within the scope of the claimed subject matter. Other advantages and novel features will become apparent from the following detailed description when considered in conjunction with the drawings.

### BRIEF DESCRIPTION OF THE DRAWINGS

FIG. 1 illustrates an embodiment of a system.

FIG. 2 illustrates an embodiment of a system.

FIG. 3 illustrates a logic flow according to an embodiment.

FIG. 4 illustrates a logic flow according to an embodiment.

FIG. 5 illustrates a user interface according to an embodiment.

FIG. 6 illustrates an embodiment of a system.

FIG. 7 illustrates an embodiment of a centralized system according to an embodiment.

FIG. 8 illustrates an embodiment of a distributed system according to an embodiment.

FIG. 9 illustrates an embodiment of a computing architecture.

FIG. 10 illustrates an embodiment of a communications architecture.

### DETAILED DESCRIPTION

Various embodiments are generally directed to techniques for selecting among multiple application software modules by a bootloader of a welding or cutting system. Techniques described herein may include a bootloader component of a welding system to determine that more than one application software module is available for the welding system. A display device may be configured to display user interface components configured to allow user selection of one or more application software modules. An input device may be configured to receive a selection of one of the one or more application software modules. A processor of the welding system may be configured to execute the selected one or more application software modules. Other embodiments are described and claimed.

Reference is now made to the drawings, wherein like reference numerals are used to refer to like elements throughout. In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives consistent with the claimed subject matter.

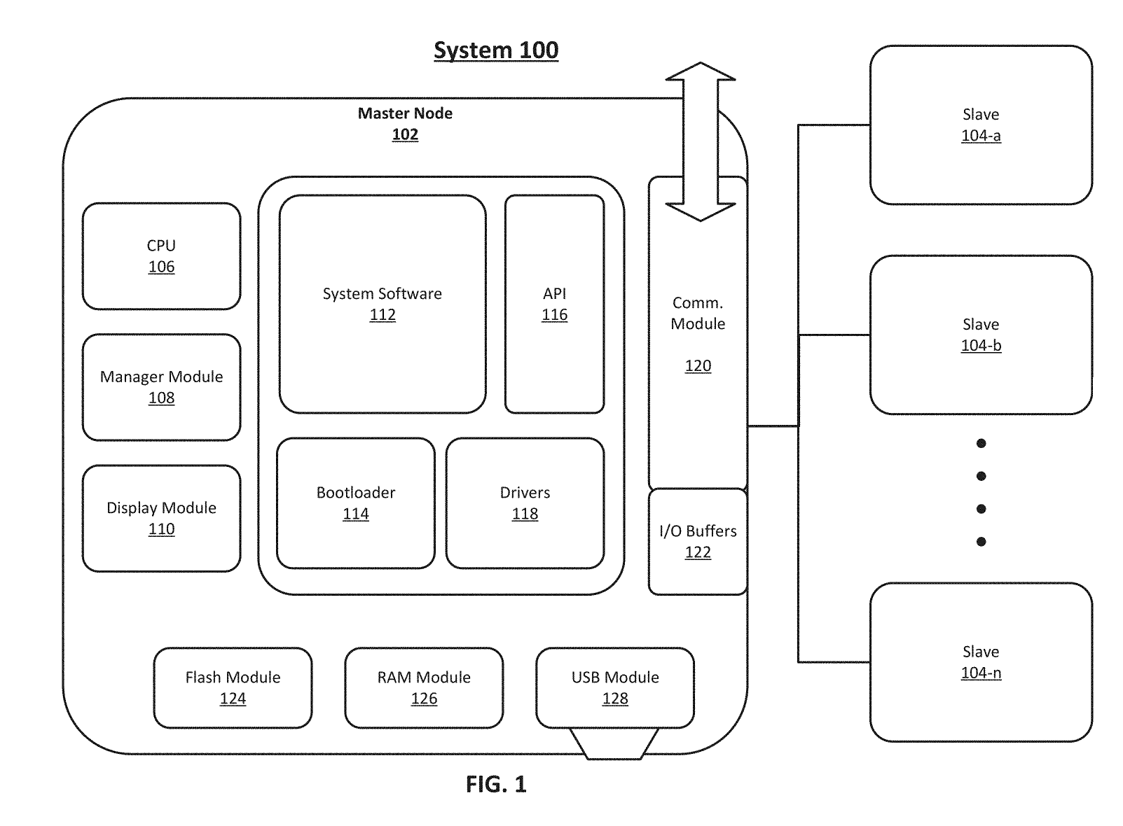

FIG. 1 illustrates a block diagram for a system 100, which may comprise a welding or cutting system in some embodiments. The system 100 may comprise one or more components configured to operate according to the embodiments and logic flows described herein. Although the system 100 shown in FIG. 1 has a limited number of elements in a certain topology, it may be appreciated that the system 100 may include more or less elements in alternate topologies as desired for a given implementation. The system 100 may include a master node 102, which may be generally operative to interact with one or more components or modules within system 100. Master node 102 may include one or more processing units, storage units, network interfaces, or other hardware and software elements, described in more detail below. Master node 102 may be one component of an overall welding or cutting system, such as a power source, and may be connected to other components, described herein.

In an embodiment, each component may comprise a device, such as a master node or slave node, comprising a network-connected storage device or multiple storage devices, such as one of the storage devices described in more detail herein. In an example, slave nodes 104-a through 104-n may include one or more devices used to access software or services provided by master node 102. For example, slave nodes 104 may include without limitation external user interface panels, internal user interface panels, wire feeders, power sources, or non-welding or cutting peripherals such as a mobile device, a personal digital assistant, a mobile computing device, a smart phone, a cellular telephone, a handset, a one-way pager, a two-way pager, a messaging device, a computer, a personal computer (PC), a desktop computer, a laptop computer, a notebook computer, a handheld computer, a tablet computer, a wearable computing device such as a smart watch, a server, a server array or server farm, a web server, a network server, an Internet server, a work station, a mini-computer, a mainframe computer, a supercomputer, a network appliance, a web appliance, multiprocessor systems, processor-based systems, or any combination thereof.

In various embodiments, master node 102 and the other components of system 100 may comprise or implement multiple components or modules. As used herein the terms “component” and “module” are intended to refer to welding, cutting, and/or computer-related entities, comprising either hardware, a combination of hardware and software, software, or software in execution. For example, a component and/or module can be implemented as a process running on a processor, a hard disk drive, multiple storage drives (of optical and/or magnetic storage medium), an object, an executable, a thread of execution, a program, and/or a computer. By way of illustration, both an application running on a server and the server can be a component and/or module. One or more components and/or modules can reside within a process and/or thread of execution, and a component and/or module can be localized on one computer and/or distributed between two or more computers as desired for a given implementation. The embodiments are not limited in this context.

The various devices within system 100, and components and/or modules within a device of system 100, may be communicatively coupled via various types of communications media as indicated by various lines or arrows. The devices, components and/or modules may coordinate operations between each other. The coordination may involve the uni-directional or bi-directional exchange of information. For instance, the devices, components and/or modules may communicate information in the form of non-transitory signals communicated over the communications media. The information can be implemented as signals allocated to various signal lines. In such allocations, each message is a signal. Further embodiments, however, may alternatively employ data messages. Such data messages may be sent across various connections. Exemplary connections within a device include parallel interfaces, serial interfaces, and bus interfaces. Exemplary connections between devices may comprise network connections over a wired or wireless communications network.

In various embodiments, the components and modules of the system 100 may be organized as a distributed system. A distributed system typically comprises multiple autonomous computers that communicate through a computer network. The computers interact with each other in order to achieve a common goal, such as solving computational problems. For example, a computational problem may be divided into many tasks, each of which is solved by one computer. A computer program that runs in a distributed system is called a distributed program, and distributed programming is the process of writing such programs. Examples of a distributed system may include, without limitation, a client-server architecture, a 3-tier architecture, an N-tier architecture, a tightly-coupled or clustered architecture, a peer-to-peer architecture, a master-slave architecture, a shared database architecture, and other types of distributed systems. It is worthy to note that although some embodiments may utilize a distributed system when describing various enhanced techniques for data retrieval, it may be appreciated that the enhanced techniques for data retrieval may be implemented by a single computing device as well. The embodiments are not limited in this context.

In an embodiment, master node 102 may include CPU 106, which may comprise one or more microprocessor units, as described herein. CPU 106 may be configured to execute instructions including, but not limited to, system software 112, bootloader 114, Application Programming Interface (API) 116, and drivers 118. CPU 106 may be configured to execute instructions stored on, and access/store data from, one or more non-transitory computer-readable memory locations, such as flash module 124, RAM module 126, and Universal Serial Bus (USB) module 128. In some embodiments, a network communications interface may also be used by CPU 106 to access and execute instructions. Only certain software and memory locations have been illustrated within FIG. 1 for purposes of clarity, and it can be appreciated that more or less software and memory components may be used in certain embodiments, as described further herein. Moreover, FIG. 1 does not include an illustration of the welding and cutting components typically found within welding and cutting systems, however, it can be appreciated that system 100 may include any and all necessary components for a welding and cutting system.

Master node 102 may include manager module 108, which may comprise software, or a combination of software and hardware, to manage and configure the display of a user interface on display module 110. Manager module 108 may be configured to accept and communicate user input from display module 110 and other user input devices to CPU 106. Manager module 108 may receive user interface elements from other software components, such as system software 112 and bootloader 114, for example.

In some embodiments, master node 102 may include display module 110. Display module 110 may include one or more of the display technologies described herein. Further, in some embodiments, display module 110 may be external to master node 102, and connected through one or more communications techniques. Display module may be configured by manager module 108 to display a user interface comprising user interface elements and accept input from a user into the user interface. The user interface may, in some embodiments, display a choice for one of a plurality of application software modules stored within a memory of master node 102. In response to a selection of one of the application software modules by a user, manager module 108 may instruct the relevant component of master node 102 to execute the selected application software modules.

Display module 110 may comprise a touch screen display in some embodiments. Instead of, or in addition to, a touch screen, display module 110 may include or be coupled to one or more user interface elements, such as knobs, buttons, or combined knobs/buttons that may be used by a user of system 100 to view and select user interface options.

Master node 102 may include system software 112, which may be stored in one or more computer-readable storage media. System software 112 may be stored on one or more of flash module 124, RAM module 126, and USB module 128, for example. System software 112 may be used to operate system 100, and may configure system 100 for welding and cutting operations. For example, system software 112 may include one or more application software modules, which may include operational instructions for welding or cutting processes, user interfaces for control and configuration of welding and cutting system, and all other necessary software instructions for operations of welding and cutting systems.

In an embodiment, master node 102 may include bootloader 114. Bootloader 114 may include a series of software instructions to start, or boot, system software 112. In addition, bootloader 114 may be configured to receive new software, save the received software in appropriate memory locations, and perform upgrades or replacement to existing system software 112. New software may be received either from an external storage device, such as USB module 128, or via a communications interface, such as communications module 120.

During a startup procedure, bootloader 114 may be executed first after a power on, or reset, instruction is received by system 100. Once bootloader 114 is initiated, it may begin by reading the value of a RAM variable stored within RAM module 126. The value of this variable may indicate whether the bootloader 114 should start system software 112 or stay in boot mode. The RAM variable may indicate that bootloader 114 should remain in boot mode, start system software 112, or remain in boot mode for a fix period of time and wait for a programming request before starting system software 112. In some embodiments, the step of reading a flag may be overridden by one or more instructions from a communications interface, USB module, or the like.

An application programming interface (API) module 116 may be configured to receive and execute instructions received via communications module 120. API module 116 may comprise one or more APIs, which are interfaces that software can use to access an underlying software library. In an embodiment, system software 112 may be available as a software library that may be accessed via API module 116. Like a user interface allows a user to access software on a computer, an API may provide software with access to a software library. Using one or more predefined functions, software running outside of master node 102 may request that certain software routines within a software library use API module 120.

API module 120 may utilize one or more I/O buffers 122, which may include software and hardware for storing requests received via communications module 120 and responses from master node 102. In some embodiments, many requests may be made for information, via API module 120. These requests may be stored in an input buffer and executed in order based on time or efficiency. Since certain communications protocols may only communicate information in a serial manner, one or more output buffers may store and queue output from master node 102.

Communications module 120 may include one or more communications interfaces for master node 102. Master node 102 may communicate using a plurality of electrical interfaces and protocols such as CAN, CAN2, RS-232, USB, Wi-Fi, Bluetooth, Ethernet, LoRa, EtherCAT, CANOpen, and/or any of the known communications protocols described herein. Communications module 120 may use drivers 118, which may include one or more software applications implementing various communications protocols, to implement each communications interface within master node 102.

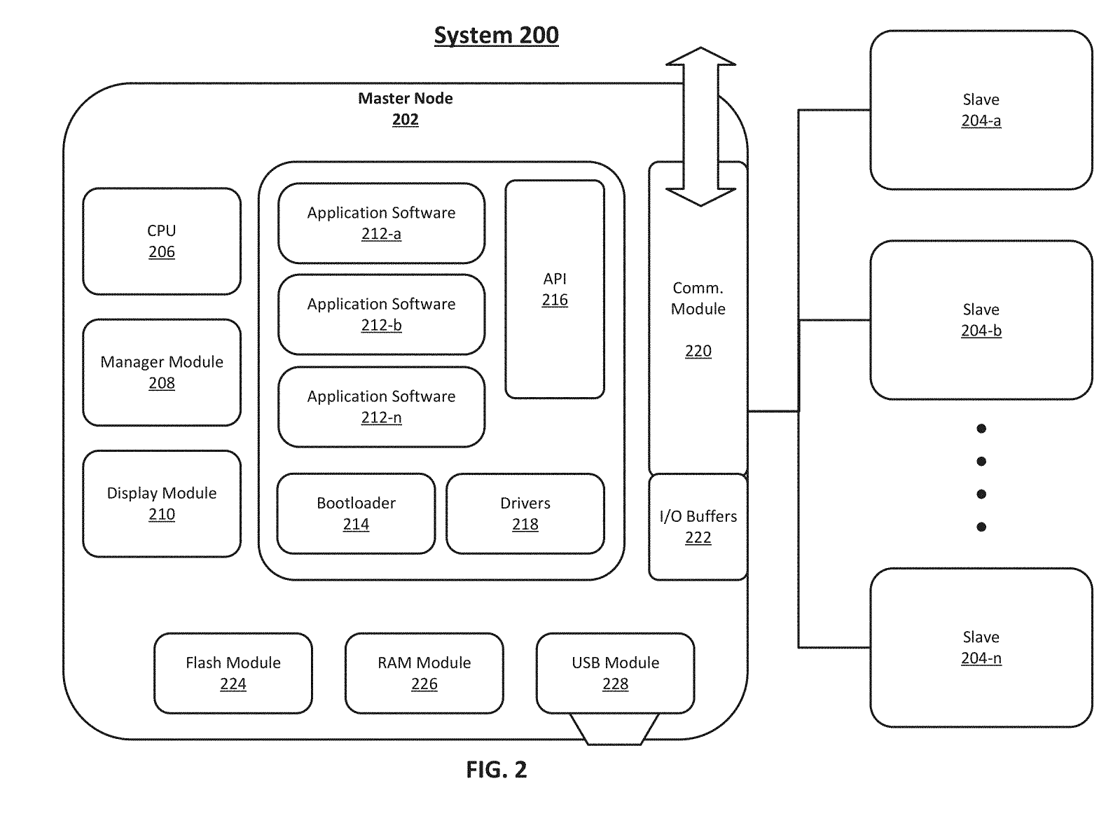

FIG. 2 illustrates a block diagram for a system 200, which may comprise a welding or cutting system in some embodiments. The system 200 may comprise one or more components configured to operate according to the embodiments and logic flows described herein. FIG. 2 includes many components similar to those described with respect to FIG. 1, and components corresponding to the description of FIG. 1 have been like-numbered. Thus, CPU 206 corresponds to CPU 106, manager module 208 corresponds to manager module 108, and I/O Buffers 222 corresponds to I/O Buffers 222. FIG. 2 illustrates an embodiment in which there are multiple application software modules 212-a through 212-n installed within master node 202. More or less application software modules may be present within a particular embodiment. Further, as described further, application software modules may comprise different versions of the same software, software with different functionality, upgraded versions of software for master node 202 or slave nodes 204 (e.g., 204-a through 204-n), and/or configuration software a welding or cutting system. While only showed in detail with respect to a master node, slave nodes may also include more than one application software module, and may incorporate the techniques described herein with respect to a master node, including one or more hardware and software components of the master node.

In an embodiment, master node 202 may include more than one application software module 212. Each application software module 212 may include instructions for the operation and/or configuration of a welding or cutting system. A first software application module may include a first version of software for a welding and cutting system. A second software application module may include a second version of the same software. In some embodiments, a software application module may include software for one or more slave nodes in a welding or cutting system. In an embodiment, a first software application module may include a first set of functionality and a second software application module may include a second set of functionality. The first set of functionality may differ from the second set of functionality. Still, in another embodiment, a software application module may include an upgrade to existing software application modules. The embodiments are not limited in this context.

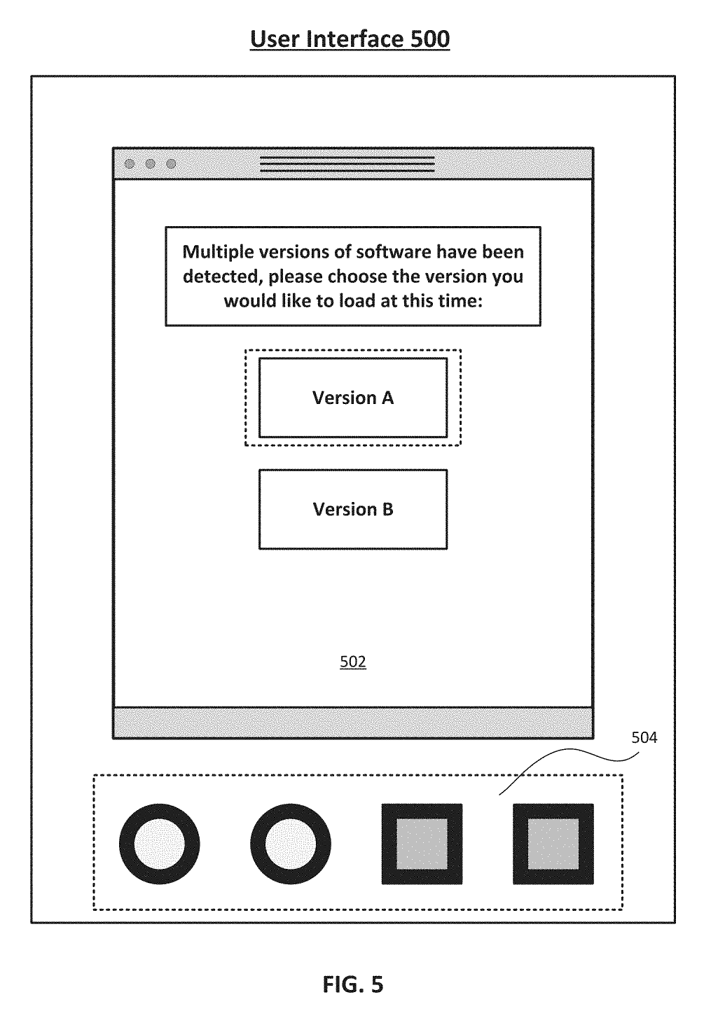

During a startup procedure, bootloader 214 may be executed first after a power on, or reset, instruction is received by system 200. Once bootloader 214 is initiated, it may begin by reading the value of a RAM variable stored within RAM module 226. The value of this variable may indicate whether the bootloader 214 should start executing one of application software modules 212 or stay in boot mode. The RAM variable may indicate that bootloader 214 should remain in boot mode, start application software modules 212, or remain in boot mode for a fix period of time and wait for a programming request before executing one of software application modules 212. Further, the RAM variable may indicate to bootloader 214 whether more than one application software module 212 is present on master node 102. In some embodiments, the step of reading a flag may be overridden by one or more instructions from a communications interface, USB module, or the like. When only a single application software module is present, that module may be the default application software module to execute. However, when more than one application software module is present, bootloader 214 may, in some embodiments, present a choice of available software application modules to a user of system 200 using display module 210. An example of this process is discussed below with respect to FIG. 5.

In an embodiment, bootloader 214 may use one or more flags stored in memory to determine which of a plurality of application software modules 212 to load upon startup. In some embodiment, a user may select a default application software module that is saved for future bootloading. In this situation, bootloader 214 may always load the default application software module, unless another user input is given, such as pressing a button, pressing a button for a predetermined amount of time during startup, selecting an option on a user interface, or other indication that the default bootloading should be modified at that time. In some embodiments, a bootloading module may receive a remote indication that a software application module other than default should be chosen. In an example, an instruction may be given by software loaded onto a USB drive and inserted into USB module 228. In another example, an instruction may be communicated via one or more communication interfaces of communications module 220.

In some embodiments, the ability to store multiple application software modules and select from among them at startup may provide for increased efficiency in upgrading software among one or more nodes within a welding and cutting system. For example, in a multi-node system, a master node 202 may include a master bootloader 214, and slave nodes 204 may include slave bootloaders (not shown). A master node 202 may monitor and control slave nodes, including monitoring and control of each slave bootloader. In an embodiment, a slave node 204 may wait for a “start application” command from a master node before a slave bootloader will exit boot mode. This may allow for a simplified upgrade of one or more slave nodes to new application software. For example, during a mass upgrade procedure, pausing all slave nodes in boot mode upon startup until they receive an indication otherwise may prevent communications and other operations within a welding or cutting system during the upgrade process.

In an embodiment, a slave node 204 may communicate to master node 202 via communications module 220 that the slave node is missing application software, or existing application software has been damaged or corrupted. The master node 202 may then communicate a new or replacement version of an application software module to the slave node so the entire welding and cutting system may continue to operate.

Included herein is a set of flow charts representative of exemplary methodologies for performing novel aspects of the disclosed architecture. While, for purposes of simplicity of explanation, the one or more methodologies shown herein, for example, in the form of a flow chart or flow diagram, are shown and described as a series of acts, it is to be understood and appreciated that the methodologies are not limited by the order of acts, as some acts may, in accordance therewith, occur in a different order and/or concurrently with other acts from that shown and described herein. For example, those skilled in the art will understand and appreciate that a methodology could alternatively be represented as a series of interrelated states or events, such as in a state diagram. Moreover, not all acts illustrated in a methodology may be required for a novel implementation.

The logic flows may be implemented using one or more hardware elements and/or software elements of the described embodiments or alternative elements as desired for a given set of design and performance constraints. For example, the logic flows may be implemented as logic (e.g., computer program instructions) for execution by a logic device (e.g., a general-purpose or specific-purpose computer). For example, a logic flow may be implemented by a processor component executing instructions stored on an article of manufacture, such as a storage medium or a computer-program product. A storage medium may comprise any non-transitory computer-readable medium or machine-readable medium, such as an optical, magnetic or semiconductor storage. The storage medium may store various types of computer executable instructions, such as instructions to implement one or more disclosed logic flows. Examples of a computer readable or machine readable storage medium may include any tangible media capable of storing electronic data, including volatile memory or non-volatile memory, removable or non-removable memory, erasable or non-erasable memory, writeable or re-writeable memory, and so forth. Examples of computer executable instructions may include any suitable type of code, such as source code, compiled code, interpreted code, executable code, static code, dynamic code, object-oriented code, visual code, script files, and the like. The embodiments are not limited in this context.

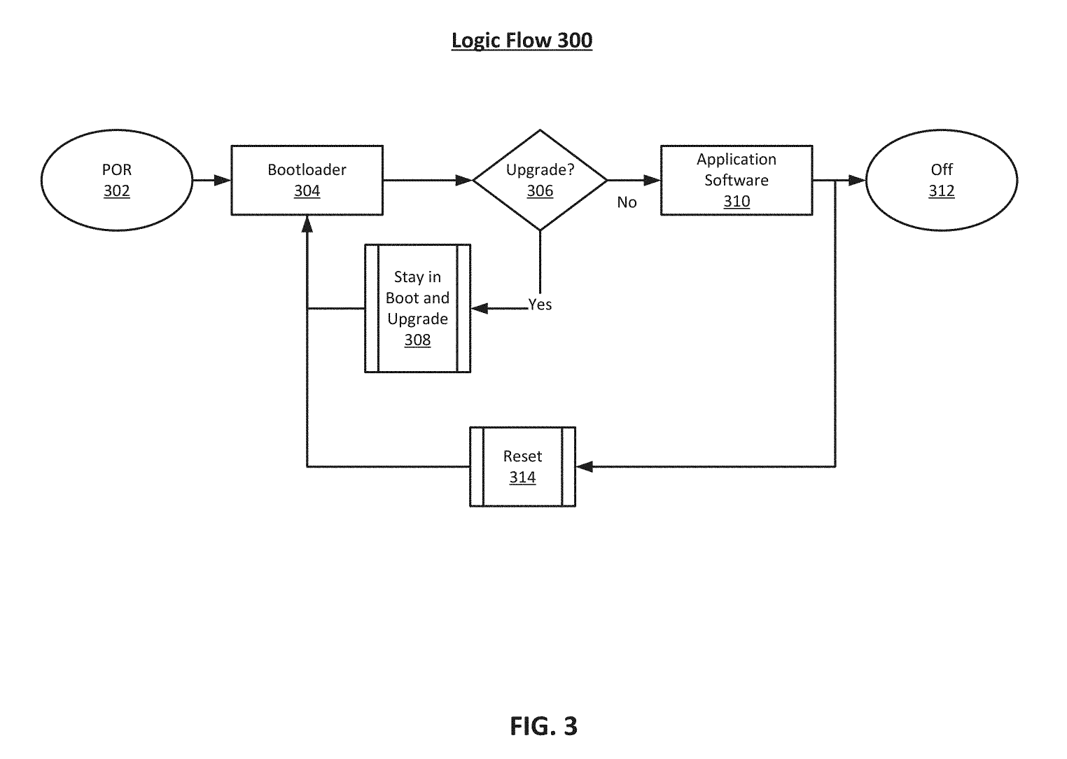

FIG. 3 illustrates one embodiment of a logic flow 300. The logic flow 300 may be representative of some or all of the operations executed by one or more embodiments described herein. For instance, the logic flow 300 may be representative of some or all of the operations executed by system 100 or system 200, and the components and modules included therein.

At 302, a power on or reset command may be communicated to a bootloader component of a node of a welding or cutting system. The command may be issued on either a master or slave node, or issued to multiple nodes serially or in parallel, or via any network interface, or via any HMI, such as a panel, button, or other interaction interface.

At 304, a bootloader component may be initialized, in which the bootloader component may search one or more memory locations of its node, a USB file, or network location, or a remote node, for a flag or indication. A flag or indication may also be entered via any HMI, such as a panel, button, or other interaction interface. Flags or indications may instruct a bootloader module to boot a particular application software module, remain in boot mode, perform an upgrade to one or more application software modules, or other operations discussed herein.

At 306, a bootloader module may detect an upgrade flag, which may trigger the bootloading module to stay in boot mode, obtain the upgrade, initiate and execute the upgrade, and return to bootloading step 304. The upgrade may be performed on a master node, slave node(s), or both. If an upgrade flag is not detected, the bootloader module may proceed to initialize an application software module at 310. Otherwise, the system stays in boot mode, and the upgrade is performed.

At 312, a welding or cutting system may receive a power off command and power off system, and at 314, a reset command may be received in which the bootloading step 304 is initialized.

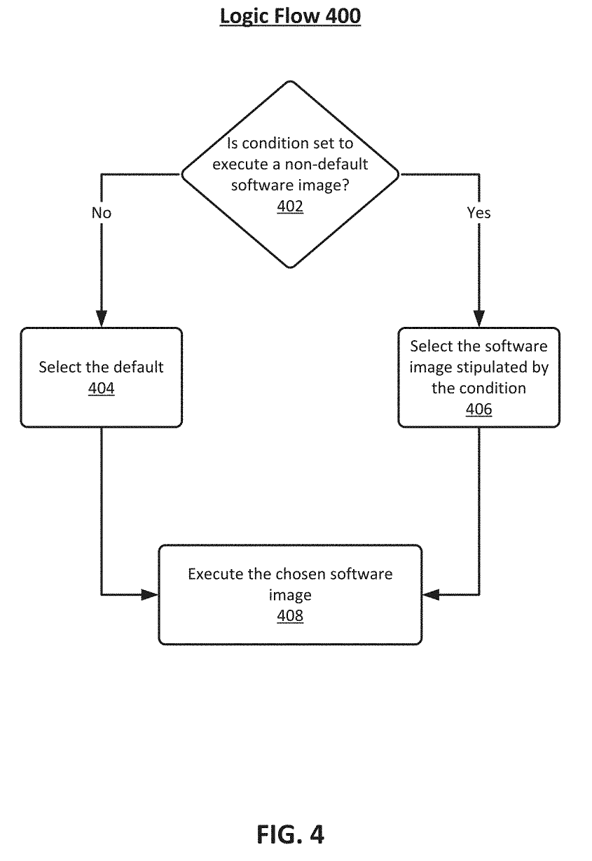

FIG. 4 illustrates one embodiment of a logic flow 400. The logic flow 400 may be representative of some or all of the operations executed by one or more embodiments described herein. For instance, the logic flow 400 may be representative of some or all of the operations executed by system 100 or system 200, and the components and modules included therein. Logic flow 400 may represent a set or subset of functions performed by a bootloader module of a node of a welding or cutting system.

At 402, a bootloader module may check whether a condition is set to execute a non-default application software module. As previously discussed, a flag may be set, or may be initiated during startup, that indicates a previously-selected default application software module should be skipped in favor of another application software module.

At 404, when a flag is not set to execute a non-default application software module, a bootloader module may select the default application software module.

At 406, when a flag is set to select a non-default application software module, a bootloader module may choose a particular application software module indicated by the flag, or may request a selection of another application software module from a user or another node of the welding or cutting system.

At 408, a bootloader module may execute the chosen application software module on the system.

FIG. 5 illustrates a user interface 500 according to an embodiment. User interface 500 may be part of a welding or cutting system and may be displayed on a display device of the system. User interface 500 may be part of a GUI of a welding or cutting system and may make up a portion of the GUI, or may constitute a standalone GUI in some embodiments. User interface 500 may include one or more user interface elements. While some user interface elements may be specifically described with respect to certain embodiments, more or less of the illustrated user interface elements may be present within an embodiment. User interface 500 may be generated by a processor of a node of a welding or cutting system and displayed on a display of the node, or associated with the node.

In some embodiments, user interface 500 may include a selection screen 502. Selection screen 502 may be displayed to a user of a system in various situations. For example, selection screen 502 may be displayed always upon start-up or reset of a system, upon an indication that a default application software module should not be used, upon detection by a bootloader module that multiple application software modules are present on a node of the system, or within a settings panel of a GUI. In any event, selection screen 502 may indicate to a user that multiple versions of software have been detected on the node, and ask the user to select one. In some embodiment, other messages may be shown. For example, when an out-of-date node has been detected, a message may appear informing the user that part or all of the system may need to be upgraded to continue. The user may then choose to perform an upgrade now, or later. The embodiments are not limited in this context.

User interface 500 may further include user input elements 504, which may be physical buttons, physical knobs, physical knobs with built-in button functionality, or virtual user interface elements that can be selected using a touch screen, or using physical components to interact with user interface 500.

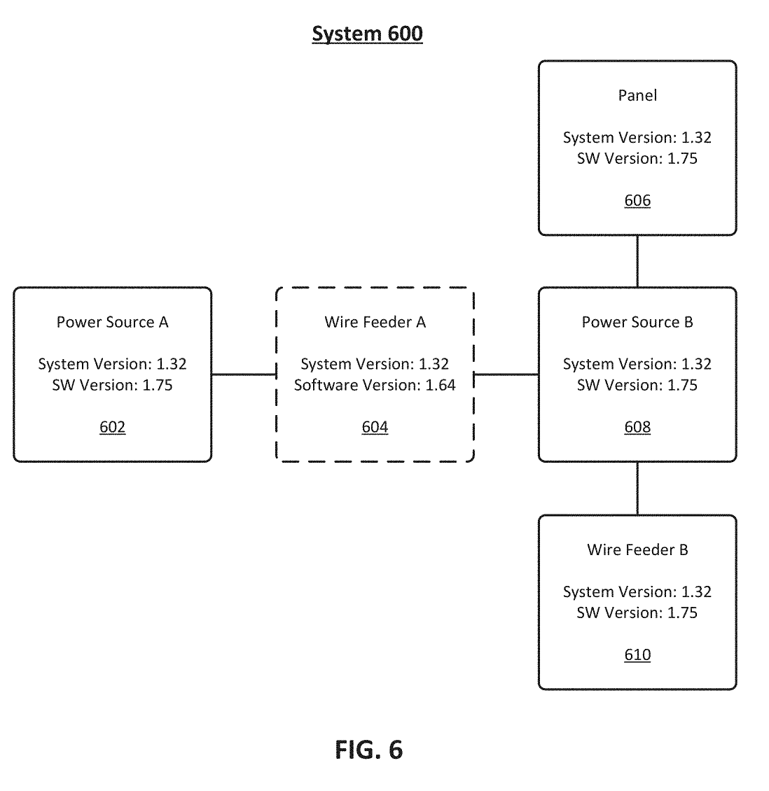

FIG. 6 illustrates a block diagram of a system 600, which may comprise a welding or cutting system in some embodiments. System 600 may illustrate a system with multiple distributed nodes connected via one or more communications protocols. Nodes may be masters or slaves, and may be different types of components within a welding or cutting system. For example, a node may be a power source, a wire feeder, a display panel, and so on. System 600 includes 5 nodes, however, one can appreciate that more or less nodes may be present in any given system. Specifically, system 600 may include power source A 602, wire feeder A 604, panel 606, power source B 608, and wire feeder B 610.

In an embodiment, a master node, such as power source A 602, may determine that another node, such as wire feeder A 604 has outdated software. When this determination has been made, a master node may push a software update to the node with outdated software, and remedy the problem before the system starts up. In an example, a master node may store one or more versions of application software modules in its memory, so that upgrades may be made to other nodes within system 600.

In an embodiment, and considering the distributed nature of system 600, a master node may have the ability to prepare a file to clone an entire welding or cutting system. Given the ability for a master node to apply a system release to an entire system and the ability to access other nodes, including a logical block structure of those nodes, a master node may be configured to retrieve and store configuration information capable of cloning an entire welding or cutting system. In one embodiment, configuration information for one system may be determined and stored using an external memory device, such as a USB memory device. The configuration information may be transferred using the USB-memory device to a master node of a target system. The USB memory device may contain a command file which extracts the contents of each node in the source system and may send it to the master node, which in turn puts the data on the USB-memory in a known format.

When the USB memory device is inserted in the master bootloader of a target system, it may download both the application software module and the settings to each comparable node in the target system, essentially making it a clone of the source system. Performing this action either over a network or USB may help the user set up a reference welding or cutting apparatus which is used to maintain a fleet of machines behaving essentially identically, having the same performance and features.

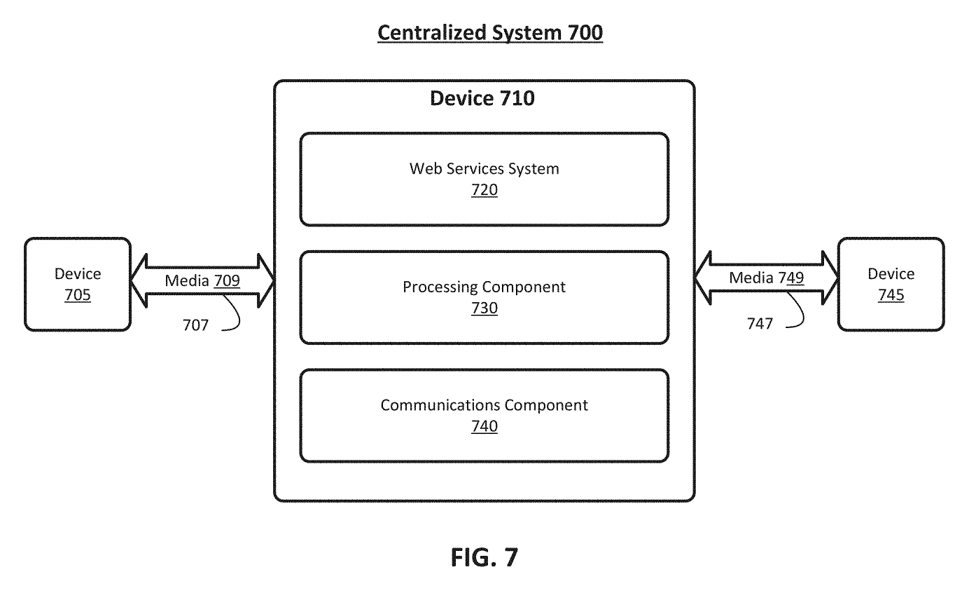

FIG. 7 illustrates a block diagram of a centralized system 700. The centralized system 700 may implement some or all of the structure and/or operations for the web services system 720 in a single computing entity, such as entirely within a single device 710. By way of example, and not limitation, one or more of the embodiments described herein may use the components and techniques described with respect to FIG. 7 for centralized and/or distributed operations. In some embodiments, a welding or cutting system may utilize one or more of the techniques described with respect to FIG. 7.

The device 710 may comprise any electronic device capable of receiving, processing, and sending information for the web services system 720. Examples of an electronic device may include without limitation a welding or cutting machine, computer, a personal computer (PC), a desktop computer, a laptop computer, a notebook computer, a netbook computer, a handheld computer, a tablet computer, a server, a server array or server farm, a web server, a network server, an Internet server, a work station, a main frame computer, a supercomputer, a network appliance, a web appliance, a distributed computing system, multiprocessor systems, processor-based systems, wireless access point, base station, subscriber station, radio network controller, router, hub, gateway, bridge, switch, machine, or combination thereof. The embodiments are not limited in this context.

The device 710 may execute processing operations or logic for the web services system 720 using a processing component 730. The processing component 730 may comprise various hardware elements, software elements, or a combination of both. Examples of hardware elements may include devices, logic devices, components, processors, microprocessors, circuits, processor circuits, circuit elements (e.g., transistors, resistors, capacitors, inductors, and so forth), integrated circuits, application specific integrated circuits (ASIC), programmable logic devices (PLD), digital signal processors (DSP), field programmable gate array (FPGA), memory units, logic gates, registers, semiconductor device, chips, microchips, chip sets, and so forth. Examples of software elements may include software components, programs, applications, computer programs, application programs, system programs, software development programs, machine programs, operating system software, middleware, firmware, software modules, routines, subroutines, functions, methods, procedures, software interfaces, application program interfaces (API), instruction sets, computing code, computer code, code segments, computer code segments, words, values, symbols, or any combination thereof. Determining whether an embodiment is implemented using hardware elements and/or software elements may vary in accordance with any number of factors, such as desired computational rate, power levels, heat tolerances, processing cycle budget, input data rates, output data rates, memory resources, data bus speeds and other design or performance constraints, as desired for a given implementation.

The device 710 may execute communications operations or logic for the web services system 720 using communications component 740. The communications component 740 may implement any well-known communications techniques and protocols, such as techniques suitable for use with packet-switched networks (e.g., public networks such as the Internet, private networks such as an enterprise intranet, and so forth), circuit-switched networks (e.g., the public switched telephone network), or a combination of packet-switched networks and circuit-switched networks (with suitable gateways and translators). The communications component 740 may include various types of standard communication elements, such as one or more communications interfaces, network interfaces, network interface cards (NIC), radios, wireless transmitters/receivers (transceivers), wired and/or wireless communication media, physical connectors, and so forth. By way of example, and not limitation, communication media 709, 749 include wired communications media and wireless communications media. Examples of wired communications media may include a wire, cable, metal leads, printed circuit boards (PCB), backplanes, switch fabrics, semiconductor material, twisted-pair wire, co-axial cable, fiber optics, a propagated signal, and so forth. Examples of wireless communications media may include acoustic, radio-frequency (RF) spectrum, infrared and other wireless media.

The device 710 may communicate with other devices 705, 745 over a communications media 709, 749, respectively, using communications signals 707, 747, respectively, via the communications component 740. The devices 705, 745, may be internal or external to the device 710 as desired for a given implementation. Examples of devices 705, 745 may include, but are not limited to, a mobile device, a personal digital assistant (PDA), a mobile computing device, a smart phone, a telephone, a digital telephone, a cellular telephone, ebook readers, a handset, a one-way pager, a two-way pager, a messaging device, consumer electronics, programmable consumer electronics, game devices, television, digital television, or set top box.

For example, device 705 may correspond to a client device such as a phone used by a user. Signals 707 sent over media 709 may therefore comprise communication between the phone and the web services system 720 in which the phone transmits a request and receives a web page in response.

Device 745 may correspond to a second user device used by a different user from the first user, described above. In one embodiment, device 745 may submit information to the web services system 720 using signals 747 sent over media 749 to construct an invitation to the first user to join the services offered by web services system 720. For example, if web services system 720 comprises a social networking service, the information sent as signals 747 may include a name and contact information for the first user, the contact information including phone number or other information used later by the web services system 720 to recognize an incoming request from the user. In other embodiments, device 745 may correspond to a device used by a different user that is a friend of the first user on a social networking service, the signals 747 including status information, news, images, or other social-networking information that is eventually transmitted to device 705 for viewing by the first user as part of the social networking functionality of the web services system 720.

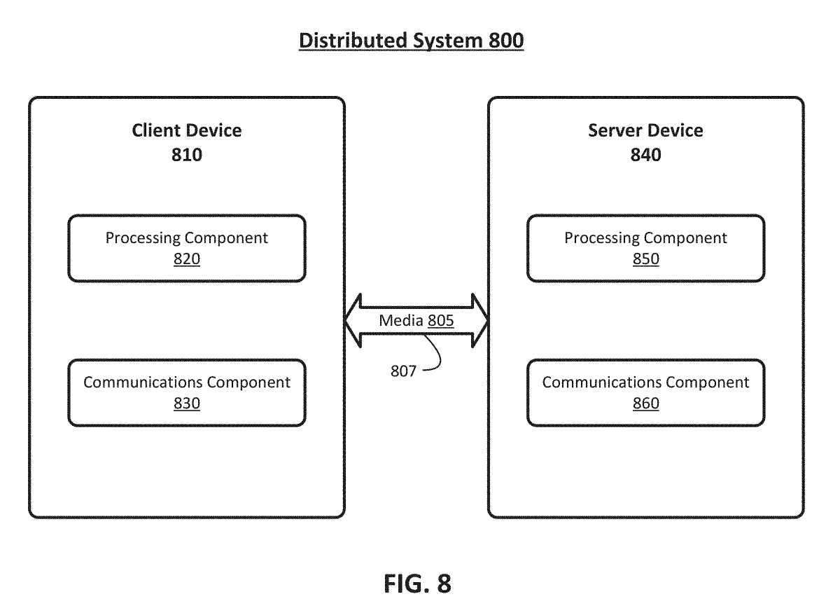

FIG. 8 illustrates a block diagram of a distributed system 800. The distributed system 800 may distribute portions of the structure and/or operations for the disclosed embodiments across multiple computing entities, such as two or more nodes of a welding or cutting system. Examples of distributed system 800 may include without limitation a client-server architecture, a 3-tier architecture, an N-tier architecture, a tightly-coupled or clustered architecture, a peer-to-peer architecture, a master-slave architecture, a shared database architecture, and other types of distributed systems. The embodiments are not limited in this context.

The distributed system 800 may comprise a client device 810 and a server device 840. In general, the client device 810 and the server device 840 may be the same or similar to device 710 as described with reference to FIG. 7. For instance, the client device 810 and the server device 840 may each comprise a processing component 820, 850 and a communications component 830, 860 which are the same or similar to the processing component 730 and the communications component 740, respectively, as described with reference to FIG. 7. In another example, the devices 810 and 840 may communicate over a communications media 805 using media 805 via signals 807.

The client device 810 may comprise or employ one or more client programs that operate to perform various methodologies in accordance with the described embodiments. In one embodiment, for example, the client device 810 may implement some steps described with respect client devices described in the preceding figures.

The server device 840 may comprise or employ one or more server programs that operate to perform various methodologies in accordance with the described embodiments. In one embodiment, for example, the server device 840 may implement some steps described with respect to server devices described in the preceding figures

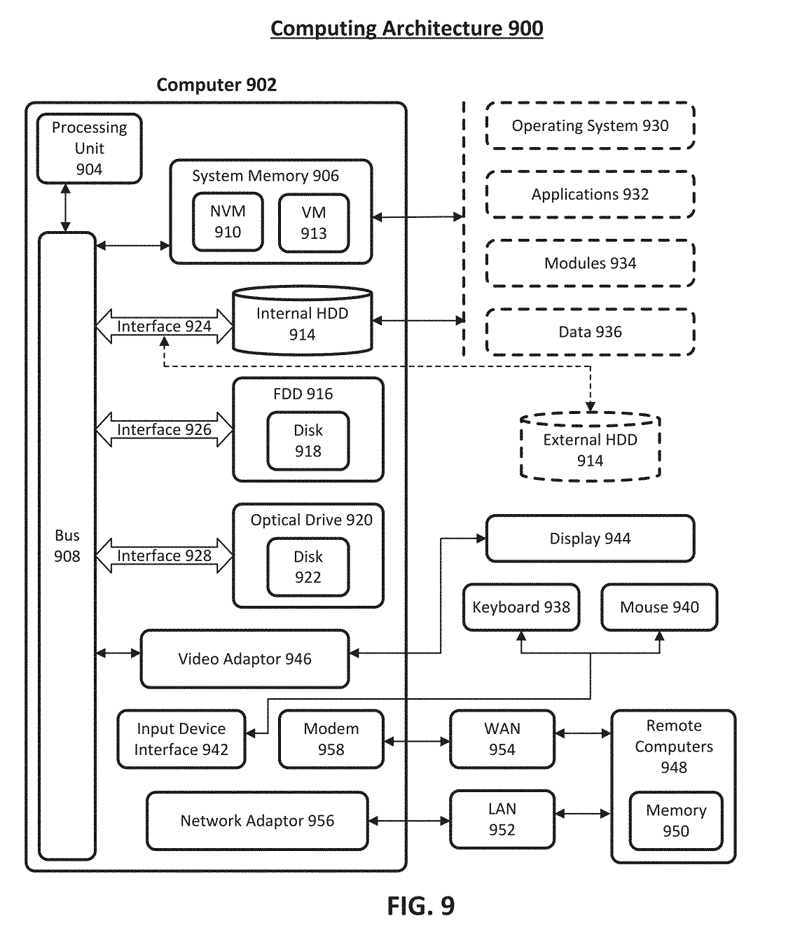

FIG. 9 illustrates an embodiment of an exemplary computing architecture 900 suitable for implementing various embodiments as previously described. In one embodiment, the computing architecture 900 may comprise or be implemented as part of an electronic device. Examples of an electronic device may include those described herein, such as a welding or cutting system and/or one or more nodes therein. The embodiments are not limited in this context.

As used in this application, the terms “system” and “component” are intended to refer to a computer-related entity, either hardware, a combination of hardware and software, software, or software in execution, examples of which are provided by the exemplary computing architecture 900. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers. Further, components may be communicatively coupled to each other by various types of communications media to coordinate operations. The coordination may involve the uni-directional or bi-directional exchange of information. For instance, the components may communicate information in the form of signals communicated over the communications media. The information can be implemented as signals allocated to various signal lines. In such allocations, each message is a signal. Further embodiments, however, may alternatively employ data messages. Such data messages may be sent across various connections. Exemplary connections include parallel interfaces, serial interfaces, and bus interfaces.

The computing architecture 900 includes various common computing elements, such as one or more processors, multi-core processors, co-processors, memory units, chipsets, controllers, peripherals, interfaces, oscillators, timing devices, video cards, audio cards, multimedia input/output (I/O) components, power supplies, and so forth. The embodiments, however, are not limited to implementation by the computing architecture 900.

As shown in FIG. 9, the computing architecture 900 comprises a processing unit 904, a system memory 906 and a system bus 908. The processing unit 904 can be any of various commercially available processors, including without limitation an AMD® Athlon®, Duron® and Opteron® processors; ARM® application, embedded and secure processors; IBM® and Motorola® DragonBall® and PowerPC® processors; IBM and Sony® Cell processors; Intel® Celeron®, Core (2) Duo®, Itanium®, Pentium®, Xeon®, and XScale® processors; and similar processors. Dual microprocessors, multi-core processors, and other multi-processor architectures may also be employed as the processing unit 904.

The system bus 908 provides an interface for system components including, but not limited to, the system memory 906 to the processing unit 904. The system bus 908 can be any of several types of bus structures that may further interconnect to a memory bus (with or without a memory controller), a peripheral bus, and a local bus using any of a variety of commercially available bus architectures. Interface adapters may connect to the system bus 908 via a slot architecture. Example slot architectures may include without limitation Accelerated Graphics Port (AGP), Card Bus, (Extended) Industry Standard Architecture ((E)ISA), Micro Channel Architecture (MCA), NuBus, Peripheral Component Interconnect (Extended) (PCI(X)), PCI Express, Personal Computer Memory Card International Association (PCMCIA), and the like.

The computing architecture 900 may comprise or implement various articles of manufacture. An article of manufacture may comprise a computer-readable storage medium to store logic. Examples of a computer-readable storage medium may include any tangible media capable of storing electronic data, including volatile memory or non-volatile memory, removable or non-removable memory, erasable or non-erasable memory, writeable or re-writeable memory, and so forth. Examples of logic may include executable computer program instructions implemented using any suitable type of code, such as source code, compiled code, interpreted code, executable code, static code, dynamic code, object-oriented code, visual code, and the like. Embodiments may also be at least partly implemented as instructions contained in or on a non-transitory computer-readable medium, which may be read and executed by one or more processors to enable performance of the operations described herein.

The system memory 906 may include various types of computer-readable storage media in the form of one or more higher speed memory units, such as read-only memory (ROM), random-access memory (RAM), dynamic RAM (DRAM), Double-Data-Rate DRAM (DDRAM), synchronous DRAM (SDRAM), static RAM (SRAM), programmable ROM (PROM), erasable programmable ROM (EPROM), electrically erasable programmable ROM (EEPROM), flash memory, polymer memory such as ferroelectric polymer memory, ovonic memory, phase change or ferroelectric memory, silicon-oxide-nitride-oxide-silicon (SONOS) memory, magnetic or optical cards, an array of devices such as Redundant Array of Independent Disks (RAID) drives, solid state memory devices (e.g., USB memory, solid state drives (SSD) and any other type of storage media suitable for storing information. In the illustrated embodiment shown in FIG. 9, the system memory 906 can include non-volatile memory 910 and/or volatile memory 913. A basic input/output system (BIOS) can be stored in the non-volatile memory 910.

The computer 902 may include various types of computer-readable storage media in the form of one or more lower speed memory units, including an internal (or external) hard disk drive (HDD) 914, a magnetic floppy disk drive (FDD) 916 to read from or write to a removable magnetic disk 918, and an optical disk drive 920 to read from or write to a removable optical disk 922 (e.g., a CD-ROM, DVD, or Blu-ray). The HDD 914, FDD 916 and optical disk drive 920 can be connected to the system bus 908 by a HDD interface 924, an FDD interface 926 and an optical drive interface 928, respectively. The HDD interface 924 for external drive implementations can include at least one or both of Universal Serial Bus (USB) and IEEE 1394 interface technologies.

The drives and associated computer-readable media provide volatile and/or nonvolatile storage of data, data structures, computer-executable instructions, and so forth. For example, a number of program modules can be stored in the drives and memory units 910, 913, including an operating system 930, one or more application programs 932, other program modules 934, and program data 936. In one embodiment, the one or more application programs 932, other program modules 934, and program data 936 can include, for example, the various applications and/or components to implement the disclosed embodiments.

A user can enter commands and information into the computer 902 through one or more wire/wireless input devices, for example, a keyboard 938 and a pointing device, such as a mouse 940. Other input devices may include microphones, infra-red (IR) remote controls, radio-frequency (RF) remote controls, knobs, buttons, game pads, stylus pens, card readers, dongles, finger print readers, gloves, graphics tablets, joysticks, keyboards, retina readers, touch screens (e.g., capacitive, resistive, etc.), trackballs, trackpads, sensors, styluses, and the like. These and other input devices are often connected to the processing unit 904 through an input device interface 942 that is coupled to the system bus 908, but can be connected by other interfaces such as a parallel port, IEEE 1394 serial port, a game port, a USB port, an IR interface, and so forth.

A display 944 is also connected to the system bus 908 via an interface, such as a video adaptor 946. The display 944 may be internal or external to the computer 902. In addition to the display 944, a computer typically includes other peripheral output devices, such as speakers, printers, and so forth.

The computer 902 may operate in a networked environment using logical connections via wire and/or wireless communications to one or more remote computers, such as a remote computer 948. The remote computer 948 can be a workstation, a server computer, a router, a personal computer, portable computer, microprocessor-based entertainment appliance, a peer device or other common network node, and typically includes many or all of the elements described relative to the computer 902, although, for purposes of brevity, only a memory/storage device 950 is illustrated. The logical connections depicted include wire/wireless connectivity to a local area network (LAN) 952 and/or larger networks, for example, a wide area network (WAN) 954. Such LAN and WAN networking environments are commonplace in offices and companies, and facilitate enterprise-wide computer networks, such as intranets, all of which may connect to a global communications network, for example, the Internet.

When used in a LAN networking environment, the computer 902 is connected to the LAN 952 through a wire and/or wireless communication network interface or adaptor 956. The adaptor 956 can facilitate wire and/or wireless communications to the LAN 952, which may also include a wireless access point disposed thereon for communicating with the wireless functionality of the adaptor 956.

When used in a WAN networking environment, the computer 902 can include a modem 958, or is connected to a communications server on the WAN 954, or has other means for establishing communications over the WAN 954, such as by way of the Internet. The modem 958, which can be internal or external and a wire and/or wireless device, connects to the system bus 908 via the input device interface 942. In a networked environment, program modules depicted relative to the computer 902, or portions thereof, can be stored in the remote memory/storage device 950. It will be appreciated that the network connections shown are exemplary and other means of establishing a communications link between the computers can be used.

The computer 902 is operable to communicate with wire and wireless devices or entities using the IEEE 802 family of standards, such as wireless devices operatively disposed in wireless communication (e.g., IEEE 802.11 over-the-air modulation techniques). This includes at least Wi-Fi (or Wireless Fidelity), WiMax, and Bluetooth™ wireless technologies, among others. Thus, the communication can be a predefined structure as with a conventional network or simply an ad hoc communication between at least two devices. Wi-Fi networks use radio technologies called IEEE 802.11x (a, b, g, n, etc.) to provide secure, reliable, fast wireless connectivity. A Wi-Fi network can be used to connect computers to each other, to the Internet, and to wire networks (which use IEEE 802.3-related media and functions).

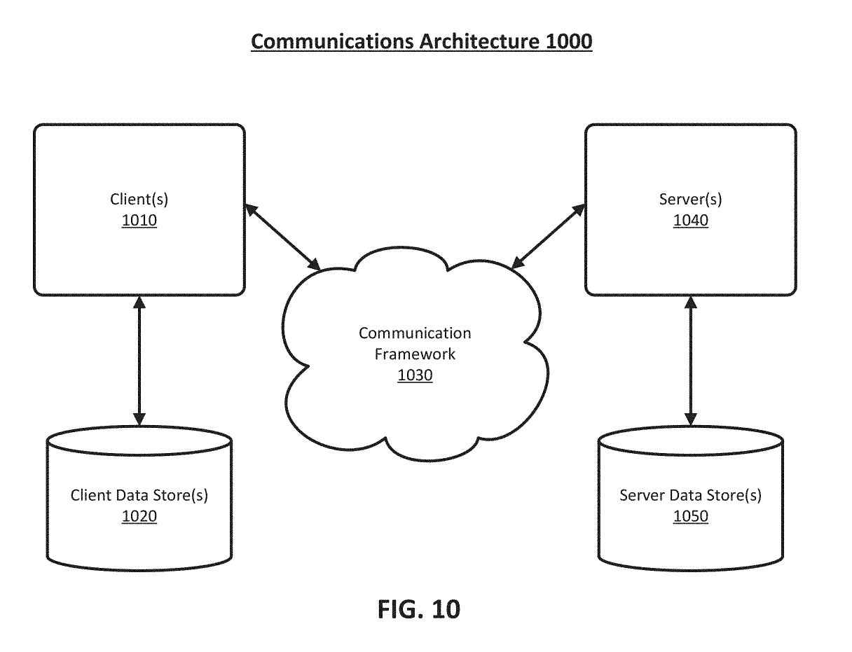

FIG. 10 illustrates a block diagram of an exemplary communications architecture 1000 suitable for implementing various embodiments as previously described. The communications architecture 1000 includes various common communications elements, such as a transmitter, receiver, transceiver, radio, network interface, baseband processor, antenna, amplifiers, filters, power supplies, and so forth. The embodiments, however, are not limited to implementation by the communications architecture 1000.

As shown in FIG. 10, the communications architecture 1000 comprises includes one or more clients 1010 and servers 1040. The clients 1010 may implement the client device 1010, for example. The servers 1040 may implement the server device 1040, for example. The clients 1010 and the servers 1040 are operatively connected to one or more respective client data stores 1020 and server data stores 1050 that can be employed to store information local to the respective clients 1010 and servers 1040, such as cookies and/or associated contextual information.

The clients 1010 and the servers 1040 may communicate information between each other using a communication framework 1030. The communications framework 1030 may implement any well-known communications techniques and protocols. The communications framework 1030 may be implemented as a packet-switched network (e.g., public networks such as the Internet, private networks such as an enterprise intranet, and so forth), a circuit-switched network (e.g., the public switched telephone network), or a combination of a packet-switched network and a circuit-switched network (with suitable gateways and translators).

The communications framework 1030 may implement various network interfaces arranged to accept, communicate, and connect to a communications network. A network interface may be regarded as a specialized form of an input output interface. Network interfaces may employ connection protocols including without limitation direct connect, Ethernet (e.g., thick, thin, twisted pair 10/100/1000 Base T, and the like), token ring, wireless network interfaces, cellular network interfaces, IEEE 802.11a-x network interfaces, IEEE 802.16 network interfaces, IEEE 802.20 network interfaces, and the like. Further, multiple network interfaces may be used to engage with various communications network types. For example, multiple network interfaces may be employed to allow for the communication over broadcast, multicast, and unicast networks. Should processing requirements dictate a greater amount speed and capacity, distributed network controller architectures may similarly be employed to pool, load balance, and otherwise increase the communicative bandwidth required by clients 1010 and the servers 1040. A communications network may be any one and the combination of wired and/or wireless networks including without limitation a direct interconnection, a secured custom connection, a private network (e.g., an enterprise intranet), a public network (e.g., the Internet), a Personal Area Network (PAN), a Local Area Network (LAN), a Metropolitan Area Network (MAN), an Operating Missions as Nodes on the Internet (OMNI), a Wide Area Network (WAN), a wireless network, a cellular network, and other communications networks.

Some embodiments may be described using the expression “one embodiment” or “an embodiment” along with their derivatives. These terms mean that a particular feature, structure, or characteristic described in connection with the embodiment is included in at least one embodiment. The appearances of the phrase “in one embodiment” in various places in the specification are not necessarily all referring to the same embodiment. Further, some embodiments may be described using the expression “coupled” and “connected” along with their derivatives. These terms are not necessarily intended as synonyms for each other. For example, some embodiments may be described using the terms “connected” and/or “coupled” to indicate that two or more elements are in direct physical or electrical contact with each other. The term “coupled,” however, may also mean that two or more elements are not in direct contact with each other, but yet still co-operate or interact with each other.

With general reference to notations and nomenclature used herein, the detailed descriptions herein may be presented in terms of program procedures executed on a computer or network of computers. These procedural descriptions and representations are used by those skilled in the art to most effectively convey the substance of their work to others skilled in the art.

A procedure is here, and generally, conceived to be a self-consistent sequence of operations leading to a desired result. These operations are those requiring physical manipulations of physical quantities. Usually, though not necessarily, these quantities take the form of electrical, magnetic or optical signals capable of being stored, transferred, combined, compared, and otherwise manipulated. It proves convenient at times, principally for reasons of common usage, to refer to these signals as bits, values, elements, symbols, characters, terms, numbers, or the like. It should be noted, however, that all of these and similar terms are to be associated with the appropriate physical quantities and are merely convenient labels applied to those quantities.

Further, the manipulations performed are often referred to in terms, such as adding or comparing, which are commonly associated with mental operations performed by a human operator. No such capability of a human operator is necessary, or desirable in most cases, in any of the operations described herein which form part of one or more embodiments. Rather, the operations are machine operations. Useful machines for performing operations of various embodiments include general purpose digital computers or similar devices.

Various embodiments also relate to apparatus or systems for performing these operations. This apparatus may be specially constructed for the required purpose or it may comprise a general purpose computer as selectively activated or reconfigured by a computer program stored in the computer. The procedures presented herein are not inherently related to a particular computer or other apparatus. Various general purpose machines may be used with programs written in accordance with the teachings herein, or it may prove convenient to construct more specialized apparatus to perform the required method steps. The required structure for a variety of these machines will appear from the description given.

It is emphasized that the Abstract of the Disclosure is provided to allow a reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate embodiment. In the appended claims, the terms “including” and “in which” are used as the plain-English equivalents of the respective terms “comprising” and “wherein,” respectively. Moreover, the terms “first,” “second,” “third,” and so forth, are used merely as labels, and are not intended to impose numerical requirements on their objects.

What has been described above includes example embodiments of the present invention. It is, of course, not possible to describe every conceivable combination of components and/or methodologies, but one of ordinary skill in the art may recognize that many further combinations and permutations are possible.

1. A computer-implemented method, comprising:
determining, by a bootloader component of a welding system, that more than one application software module is available to be installed for the welding system;
displaying, at a display device, user interface components configured to allow user selection of one or more application software modules;
receiving, by an input device, a selection of one of the one or more application software modules; and
installing, by a processor of the welding system, the selected one or more application software modules.

2. The computer-implemented method of claim 1, wherein the one or more application software modules comprise different versions of the same application software module.

3. The computer-implemented method of claim 1, wherein the one or more application software modules comprise different application software modules, each with different available functionality.

4. The computer-implemented method of claim 1, wherein at least one of the one or more application software modules comprises a software upgrade.

5. The computer-implemented method of claim 4, wherein the welding system is configured to populate one or more slave nodes within the welding system with the software upgrade.

6. A welding system comprising at least one processor and at least one network interface, wherein the at least one processor is configured to:
determine, by a master node of a welding system, that one or more application software modules are available to be installed on a slave node of the welding system;
select the one or more application software modules for installation on the slave node; and
push the one or more application software modules to the slave node, wherein the one or more application software modules are installed by a processor of the slave node.

7. The welding system of claim 6, wherein the one or more application software modules are installed prior to startup of the slave node.

8. The welding system of claim 6, wherein the master node pushes the one or more application software modules to a plurality of slave nodes.

9. The welding system of claim 6, wherein at least one of the one or more application software modules comprises a software upgrade.

10. The welding system of claim 9, wherein the master node is configured to populate one or more slave nodes within the welding system with the software upgrade.

11. The welding system of claim 6, wherein the master node retrieves and stores configuration information for cloning a welding or cutting system on a target system.

12. The welding system of claim 11, wherein the master node additionally stores the one or more application software modules for cloning the welding or cutting system.

13. A welding apparatus comprising at least one processor and at least one network interface, wherein the at least one processor is configured to:
determine, by a bootloader component of a welding apparatus, that more than one application software module is available to be installed for the welding apparatus;
display, at a display device, user interface components configured to allow user selection of one or more application software modules;
receive, by an input device, a selection of one of the one or more application software modules; and
install, by a processor of the welding apparatus, the selected one or more application software modules.

14. The welding apparatus of claim 13, wherein the one or more application software modules comprise different versions of the same application software module.

15. The welding apparatus of claim 13, wherein the one or more application software modules comprise different application software modules, each with different available functionality.

16. The welding apparatus of claim 13, wherein at least one of the one or more application software modules comprises a software upgrade.

17. The welding apparatus of claim 13, wherein the welding apparatus is configured to populate one or more slave nodes within the welding system with the software upgrade.

18. An article including a computer program product embodied on a non-transitory computer readable storage media storing instructions, that, when executed by one or more processors, performs the steps of:
determining, by a bootloader component of a welding system, that more than one application software module is available to be installed for the welding system;
displaying, at a display device, user interface components configured to allow user selection of one or more application software modules;
receiving, by an input device, a selection of one of the one or more application software modules; and
installing, by a processor of the welding system, the selected one or more application software modules.

19. The computer program product of claim 18, wherein the one or more application software modules comprise different application software modules, each with different available functionality.

20. The computer program product of claim 18, wherein the welding system is configured to populate one or more slave nodes within the welding system with the software upgrade.
